(19) United States
(12) Patent Application Publication
(10) Pub. No.: US 2008/0254268 A1
(43) Pub. Date: Oct. 16, 2008

(54) COLOR TONER FOR ELECTRO PRINTING, AND PROCESS FOR PRODUCING GLASS PLATE PROVIDED WITH CERAMIC COLOR PRINT, EMPLOYING IT

(75) Inventors: Naoki Okahata, Chiyoda-ku (JP); Satoshi Kashiwabara, Chiyoda-ku (JP); Kazuo Sunahara, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/061,093

(22) Filed: Apr. 2, 2008

(30) Foreign Application Priority Data
Apr. 3, 2007 (JP) 2007-097306

(51) Int. Cl. G03G 13/20; G03G 9/087; B32B 18/00

(52) U.S. Cl. 428/210; 430/111.2; 430/109.1; 430/124.5

(57) ABSTRACT

A color toner for electro printing, whereby a ceramic color print excellent in adhesion can be printed on a glass plate surface by a simple process without using a screen plate. The color toner for electro printing comprises toner matrix particles containing from 10 to 50 parts by mass of fine inorganic pigment particles, from 5 to 40 parts by mass of a heat decomposable binder resin having a disappearance temperature T₁₀₀ of from 350 to 575° C., and from 40 to 85 parts by mass of glass frit, per 100 parts by mass of the total solid content of the toner matrix particles.

The present invention relates to a color toner for electro printing, and a process for producing a glass plate provided with a ceramic color print, employing such a color toner for electro printing.

A window glass of an automobile is held along its periphery by a urethane sealant from the car interior side, and a ceramic color print is provided to be interposed between the window glass and the urethane sealant. Such a ceramic color print is provided mainly on peripheral regions of a fixed window of an automobile on the car interior side, and has functions to prevent deterioration of the urethane sealant due to ultraviolet rays and to shield terminals of heating wires, etc. provided on peripheral portions of the window glass on the car interior side from being seen from the car exterior side. Further, in recent years, a ceramic color print having a pattern of fine dots formed by gradation, has been widely used for the purpose of improving the design.

A ceramic color print is made of a fired product of a paste mainly containing fine inorganic pigment particles (hereinafter referred to as an inorganic pigment paste). Specifically, a paste comprising heat resistant fine inorganic pigment particles and glass frit contained in a resin solution is printed on a glass plate with a predetermined pattern by screen printing, and the glass plate is heated, so that the resin content is decomposed, and the fine inorganic pigment particles are fixed on the glass plate by the glass frit to provide a ceramic color print on the glass plate (for example, Patent Document 1). As the heat resistant fine inorganic pigment particles, black ones are usually employed.

Since automobiles are mass-produced, glass plates for windows to be used for automobiles are also mass-produced. Therefore, with respect to the ceramic color print also, once the pattern is determined, it is required that the inorganic pigment paste is sequentially printed on a large number of glass plates in accordance with the determined pattern. For such mass production, screen printing of the inorganic pigment paste by means of a screen printing plate is suitable. However, e.g. in a case where a glass plate is used for a window of an automobile, the shape of the glass plate, the shape of the ceramic color print, etc. vary depending upon the models of automobiles. Accordingly, screen printing plates must be prepared depending upon the models of automobiles, and a large number of screen printing plates must be stored. Thus, development of a process for producing a glass plate provided with a ceramic color print, which requires no modification of the screen printing plate, and a material therefor, has been required.

Whereas, in recent years, a process for forming a color print in such a manner that a color toner (ink) containing fine inorganic pigment particles and a thermoplastic resin is printed on a transfer sheet for ceramics by electro printing system, and the transfer is sheet is adhered to the surface of an inorganic substrate, followed by firing, and a color toner to be used for such a process, have been proposed. As a representative example thereof, Patent Document 2 proposes a process of using a color toner having a thermoplastic resin added to a colorant obtained by mixing and melting fine inorganic pigment particles such as carbon black and glaze frit, followed by cooling and pulverization. In such a color toner, a thermoplastic resin such as a polyester type, polystyrene type or styrene/acrylate copolymer type resin is used mainly as a binder resin to transfer a print pattern made of the toner to the substrate.

Patent Document 1: JP-A-62-72545

Patent Document 2: JP-A-2000-214624

However, the process disclosed in Patent Document 2 has had such drawbacks that since a step is required that a print pattern made of the toner is transferred on a coating film made of a water-soluble polymer on the surface of the transfer sheet, and the print pattern made of the toner held on the coating film is separated from the transfer sheet and then retransferred on a substrate, the process tends to be complicated, and the transfer rate itself tends to decrease. Further, there is a problem such that the adhesion between the print pattern made of the toner and the inorganic substrate, tends to be inadequate. Further, in a case where the substrate is a glass substrate, the color of a ceramic color print as observed from the side opposite to the side of the glass substrate on which a ceramic color print is formed, is also important as the quality of the image. As found by the present inventors, even if the adhesion between the ceramic color print and the glass substrate is good, there may be a case where the difference (color difference) is large between the color of the obtained ceramic color print and the desired color to be obtained.

The present invention has been made under the above circumstances, and it is an object of the present invention to provide a color toner for electro printing, whereby a high quality ceramic color print excellent in adhesion with a small color difference can be printed on a glass plate surface by a simple process without using a screen plate, a glass plate provided with a ceramic color print, employing such a color toner, and a process for its production.

In order to solve the above problems, the present inventors have conducted an extensive study and as a result have found that in the baking process, if the removal of the binder is insufficient, the coating film is likely to break during the baking, and pores are likely to form at the interface between the ceramic color print and the substrate after the baking, whereby the color of the ceramic color print tends to depart from the is desired color, and the present invention has been accomplished on the basis of such a discovery.

Namely, the color toner for electro printing of the present invention comprises toner matrix particles containing from 10 to 50 parts by mass of fine inorganic pigment particles, from 5 to 40 parts by mass of a heat decomposable binder resin having a disappearance temperature T₁₀₀ of from 350 to 575° C., and from 40 to 85 parts by mass of glass frit, per 100 parts by mass of the total solid content of the toner matrix particles.

The maximum value Q obtained by dividing the calorific value at the time of combustion of the heat decomposable binder resin by the measured resin weight is preferably at most 100 μV/mg.

The heat decomposable binder resin is preferably such that decomposition of at least 90% thereof is at 500° C.

The heat decomposable binder resin has a melting temperature Tq of from 70 to 125° C.

The temperature Tη at which the viscosity of the heat decomposable binder resin is 10⁵ Pa·s, is preferably from 70 to 115° C.

The heat decomposable binder resin is preferably a polymer containing monomer units derived from styrene.

The glass frit is preferably a glass frit having crystallinity.

The present invention provides a process for producing a glass plate provided with a ceramic color print, which comprises a printing step of forming, by using the color toner for electro printing of the present invention, a print pattern made of the color toner for electro printing by electro printing system on a glass plate, and a baking step of heating the glass plate having the print pattern formed thereon to convert the print pattern into a ceramic thereby to form a pattern of a ceramic color print.

The heating temperature in the baking step is preferably from 600 to 740° C.

In the baking step, not only the print pattern is converted into a ceramic, but also the glass plate having the print pattern formed thereon may be subjected to thermal processing.

The present invention provides a glass plate provided with a ceramic color print, which has a pattern of a ceramic color print formed on a glass plate surface by printing and baking the color toner for electro printing of the present invention. The printing system is preferably an electro printing system.

The color difference (ΔE) of the ceramic color print formed on the glass plate surface is preferably at most 1.0.

By the color toner for electro printing of the present invention, it is possible to print a ceramic color print excellent in adhesion on a glass plate is surface by electro printing. Accordingly, no screen plate is required, and the process is also simple.

By the process for producing a glass plate provided with a ceramic color print of the present invention, it is possible to provide a ceramic color print excellent in adhesion, on a glass plate surface by electro printing, and a glass plate provided with a ceramic color print. Accordingly, no screen plate is required, and the process is also simple.

In the accompanying drawings:

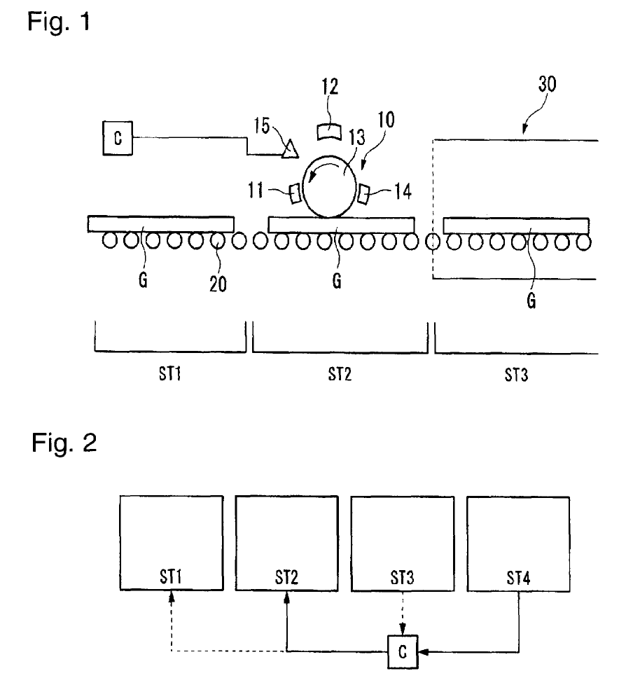

FIG. 1 is a side view schematically illustrating one example of a series of steps for production of a glass plate provided with a ceramic color print of the present invention.

FIG. 2 is a chart schematically illustrating a control process according to a preferred embodiment of the present invention.

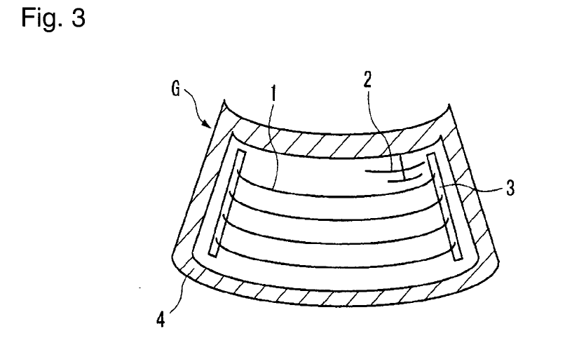

FIG. 3 is a front view illustrating one example of a rear window of an automobile.

Now, the present invention will be described in detail with reference to the preferred embodiments.

### Electro Printing

In the present invention, electro printing system is meant for printing by means of xerography system. The xerography system is based on such a system that an electrostatically charged photoconductor drum is exposed to form an electrostatic latent image, the latent image is developed with a toner to form a pattern of the toner on the surface of the photoconductor drum, and then the pattern of the toner is transferred to the surface of a substrate (the surface of a glass plate as a typical example in the case of the present invention). The present invention provides a color toner suitable for such electro printing.

### Disappearance Temperature T₁₀₀

In the present invention, the disappearance temperature T₁₀₀ of a resin represents a temperature at the time when heat generation is no longer observed in the DTA graph of a sample when the DTA graph of the sample is measured by using a differential thermal analyzer (DTA) under conditions of a heating rate of 10° C./min and a measuring temperature of from room temperature to 700° C.

Whereas, the decomposition (disappearance) ratio of a resin is such that when the DTA graph of a sample is measured by using a differential thermal analyzer under conditions of a heating rate of 10° C./min and a measuring temperature of from room temperature to 700° C., a ratio obtained by dividing the integrated value of calorific value of DTA at a certain temperature by the total calorific value, is represented by percentage.

Melting temperature Tq

In the present invention, the melting temperature Tq of a resin represents a temperature corresponding to ½ ((Smax−Smin)/2) of the difference between piston stroke Smax at the terminal point of flow and piston stroke 5 min at the starting point of flow, when the terminal point of flow and the starting point of flow are obtained from a flow curve at the time when a die of 1.0 mm in diameter×2.0 mm is set in a flow tester, and 1 g of a resin is melted and flowed through the die under conditions of a load of 980 N and a heating rate of 6° C./min.

Temperature Tη when the Viscosity is 10⁵ Pa·s

This is a temperature obtainable by a method wherein a temperature-viscosity characteristic curve of a resin is measured by using a flow tester, and from the results, the temperature is obtained when the viscosity of the resin is 10⁵ Pa·s.

### Value Q

In the present invention, the maximum value Q in calorific value at the time of combustion per unit resin weight represents the maximum value of a value (μV/mg) obtained by dividing the calorific value by the weight of the sample, when the calorific value is obtained by carrying out DTA measurement by using a differential thermal analyzer (DTA) under conditions of a heating rate of 10° C./min and a measuring temperature of from room temperature to 70° C.

### Glass Plate

In the present invention, as the glass plate, soda lime glass, alkali-free glass or quartz glass may, for example, be used.

### Production Process

Now, with respect to the process for producing a glass plate provided with a ceramic color print according to the present invention, a practical embodiment will be described with reference to drawings.

FIG. 1 is a side view schematically illustrating a series of steps in the embodiment. A glass plate G is subjected to a pretreatment step (ST1) of cutting it into a predetermined shape, followed by chamfering, cleaning, etc. and then transferred to a printing step (ST2). In the printing step (ST2), the color toner is printed on the surface of the glass plate G with a predetermined pattern by an electro printing apparatus 10 to form a print pattern made of the toner. The glass plate G having the print pattern formed thereon is carried into a heating furnace 30, wherein the baking step (ST3) is carried out. In the baking step (ST3), the glass plate G is heated at a predetermined temperature, and the toner is converted to a ceramic and baked on the glass plate G surface. The print pattern is thereby converted to a ceramic to form a ceramic color print pattern thereby to obtain a glass plate provided with a ceramic color print. The glass plate provided with the formed ceramic color print is carried to an inspection step (ST4, not shown) to inspect shielding properties. As shown in FIG. 2, inspection results in the inspection step (ST4) are transmitted to a computer C to judge whether desired shielding properties are achieved, and then converted to information for adjustment of the predetermined pattern or the toner supply amount, which is then utilized to control the print pattern in the printing step (ST2). FIG. 2 will be described hereinafter.

Now, the respective steps will be described.

### Pretreatment Step (ST1)

In the pretreatment step (ST1), a rectangular glass plate is cut into a predetermined shape, and the cut surfaces are chamfered. Then, the glass plate is cleaned, pre-heated as the case requires, and carried to the printing step ST2 by means of carrier rolls 20.

### Printing Step (ST2)

In the printing step (ST2), electricity on a photoconductor drum 13 is removed by a destaticizer 14 while the photoconductor drum 13 is rotated, and then the photoconductor drum 13 is electrified by an electrification apparatus 12, and the photoconductor drum 13 is irradiated with exposure light from a light source 15 and exposed with a predetermined pattern. Then, the exposed plane of the photoconductor drum 13 is rotated to a toner supplier 11, and the toner is supplied to the photoconductor drum 13, whereby a toner layer with a predetermined pattern is formed on the surface of the photoconductor drum 13. The toner layer with a predetermined pattern on the surface of the photoconductor drum 13 is transferred on the surface of the glass plate G carried along with rotation of the photoconductor drum 13. In such a manner, a print pattern made of a toner layer is formed on the surface of the glass plate G. The example in FIG. 1 is an example wherein the toner layer is transferred from the photoconductor drum 13 directly to the surface of the glass plate G. However, a secondary transfer plate such as an intermediate transfer belt may be present between the photoconductor drum 13 and the glass plate G.

The light source 15 is controlled by a computer C. In the computer C, pattern information to adjust the pattern shape of exposure light emitted from the light source. For example, in a case where the glass plate G is used for a window of an automobile, the shape of the glass plate G, the pattern shape of the ceramic color print to be printed on the glass plate G, etc. vary depending upon the models of automobiles. Accordingly, it is possible to easily change the shape of print pattern to be formed on the glass plate G by changing command signals from the computer C to the light source based on the pattern information depending upon the models of automobiles.

### Baking Step (ST3)

The glass plate G having a print pattern printed in the printing step (ST2) is carried into a heating furnace 30 and heated at a predetermined heating temperature (baking step (ST3)). The toner is thereby baked on the surface of the glass plate G and converted to a ceramic thereby to form a pattern of a ceramic color print. A glass plate for a window of an automobile is usually curved. Accordingly, when the glass plate G is used for a window of an automobile, it is preferred that in the baking step (ST3), not only the printed pattern is converted to a ceramic, but also the glass plate G is subjected to thermal processing. Thermal processing of a glass plate means heating a glass plate to carry out bending or tempering treatment. In the case of a glass plate for a window of an automobile, in the thermal processing, it is preferred to carry out tempering treatment after the bending. Further, in a case where the glass plate G is for a laminated glass, in the thermal processing, annealing treatment may be carried out after bending the glass plate.

### Heating Temperature in Baking Step (ST3)

The toner matrix particles of the toner contain fine inorganic pigment particles, a heat decomposable binder resin having a disappearance temperature T₁₀₀ of from 350 to 575° C. (hereinafter sometimes referred to as the binder resin) and glass frit.

When the print pattern made of the toner is heated in the baking step (ST3), the binder resin in the print pattern will be melted and decomposed, and it will be decomposed and volatilized and will disappear. Further, if the temperature exceeds the melting temperature of the glass frit, the glass frit in the print pattern will be melted. In the baking step (ST3), it is preferred that the glass frit starts to melt after the majority of the binder resin has been decomposed. In such a case, the fine inorganic pigment particles in the toner will be fixed on the glass plate surface mainly by the fixing power of the glass frit.

Further, it is preferred that the binder resin will be completely decomposed and volatilized before the glass frit is completely melted. It is thereby possible to reduce the amount of the resin remaining in the ceramic color print after the baking step (ST3).

When the binder resin is heated at a temperature where it is completely decomposed and volatilized, the print pattern will be in such a state where fine inorganic pigment particles are dispersed in the molten glass frit. At that time, the glass frit is considered to fix the fine inorganic pigment particles on the glass plate surface and at the same time to fill spaces among the fine inorganic pigment particles. Then, when the molten glass solidifies, a ceramic color print will be obtained which comprises a layer having fine inorganic pigment particles dispersed in the solidified glass.

Accordingly, the heating temperature in the baking step (ST3) is required to be at least a temperature where the binder resin and the glass frit in the toner will be melted. In this specification, “the heating temperature in the baking step” is defined by the temperature of the glass plate G in the heating furnace 30.

Specifically, the heating temperature in the baking step (ST3) is a temperature substantially equal to or higher than the after-mentioned melting temperature of the glass frit, and the after-mentioned disappearance temperature T₁₀₀ of the binder resin is preferably a temperature substantially equal to or lower than the melting temperature of the glass frit.

Further, when the melting temperature of the glass frit is taken as a standard, if the disappearance temperature T₁₀₀ of the binder resin is higher than the melting temperature of the glass frit, a decomposed product of the binder resin is likely to remain in the ceramic color print. Further, if the disappearance temperature T₁₀₀ of the binder resin is too much lower than the melting temperature of the glass frit, the binder resin will be completely decomposed before the glass frit starts to melt, whereby the ceramic pattern may not be sufficiently be fixed to the glass plate surface. Accordingly, in order to avoid such a trouble, it is preferred to select, as the binder resin, a resin having a proper T₁₀₀ depending upon the melting temperature of the glass frit.

Further, generally, the heat decomposition behavior of the heat decomposable resin is such that the calorific value at the time of combustion of the heat decomposable binder resin has a maximum value in a specific temperature range. This represents combustion of the resin, and by the combustion, the carbon content leaves from the coating film in the form of a gas such as CO or CO₂. A resin with the maximum value Q being too large, may be regarded to be such that generation of the gas is large in amount and rapid at the time of combustion. As a result, it is expected that pores will be formed due to deaeration in the coating film to be formed by the toner, such may hinder formation of a dense coating film.

Accordingly, the maximum value Q of the calorific value at the time of combustion of the binder resin is preferably not to be too large. Further, in order to design the material by taking the calorific value and generation of the gas into consideration, it is preferred that up to a certain temperature, the decomposition ratio of the binder resin becomes at least 90%, or more preferably, the decomposition reaction will substantially be completed (T₁₀₀ is definitely determined).

In the present invention, the heating temperature in the baking step (ST3) is preferably from 600 to 740° C., more preferably from 600 to 700° C. The heating temperature being at least 600° C. is preferred in that the glass frit can completely be melted, and adhesion between the ceramic color print and the glass plate surface can sufficiently be secured over a long period of time. On the other hand, when the heating temperature is at most 740° C., deformation of the glass plate can be prevented.

In a case where thermal processing is to be carried out in the baking step (ST3), the glass plate is heated to a required thermal processing temperature depending upon the type of the thermal treatment. For example, the thermal processing temperature for bending is from 600 to 700° C. Such a thermal processing temperature is usually higher than the temperature at which the binder resin and the glass frit in the toner will be melted. Accordingly, by the heating at such a thermal processing temperature in the baking step (ST3), the print pattern is baked to form a ceramic color print in the heating process.

### Color Toner

The toner is particulate. The toner particles comprise toner matrix particles containing fine inorganic pigment particles, the binder resin and glass frit. The toner may be composed solely of such toner matrix particles, or may be particles having an additive dispersed and attached on the surface of such toner matrix particles.

### Heat Decomposable Binder Resin

The binder resin will function as a binder to bind fine inorganic pigment particles and glass frit to form matrix particles. At the same time, the binder resin will function as a binder to transfer a print pattern on a photoconductor drum or on a secondary transfer plate to a substrate and as a binder to fix fine inorganic pigment particles and glass frit to the substrate until the glass frit will be melted.

Disappearance temperature T₁₀₀

The disappearance temperature T₁₀₀ of the binder resin is within a range of from 350 to 575° C. By using the binder resin having a disappearance temperature T₁₀₀ within this range, the adhesion between the ceramic color print and the glass plate is improved. The reason for such an improvement is considered to be as follows. Namely, when the disappearance temperature T₁₀₀ of the binder resin is at least 350° C. within the above range, it is possible to sufficiently fix the ceramic pattern on the glass plate surface by preventing the binder resin from being completely decomposed before the glass frit will be melted. On the other hand, when T₁₀₀ is at most 575° C., the binder resin will readily be decomposed in the baking step, and the residual carbon will not substantially remain in the ceramic color print. As a result it is possible to obtain a ceramic color print excellent in the adhesion to the glass plate surface.

Further, when T₁₀₀ is at most 575° C., the binder resin can completely be decomposed by the time glass frit starts to solidify, whereby it is possible to prevent pores formed by decomposition and volatilization of the binder resin from remaining at the interface between the ceramic color print and the glass plate. As a result, light scattering is less likely to occur at the interface, and it is possible to prevent the obtainable ceramic color print from departing from the desired color. Namely, it is considered possible to reduce the difference (color difference ΔE) between the desired color of the ceramic color print and the color actually obtained. T₁₀₀ is more preferably from 350 to 500° C., particularly preferably from 400 to 450° C.

Melting temperature Tq

The melting temperature Tq of the binder resin is preferably from 70 to 125° C. When the melting temperature Tq is at most 125° C., the binder resin can easily be sufficiently melted in the step of transferring the toner layer to the glass plate surface. When the binder resin is sufficiently melted, the leveling property of the toner layer will be improved, and in the baking step, the binder resin tends to easily be decomposed uniformly. Accordingly, pinholes, cracks or voids are less likely to be formed in the ceramic color print. As a result, a ceramic color print excellent in flatness and smoothness can be obtained. Pinholes, cracks or voids in the ceramic color print tend to cause an increase in the color difference ΔE and a decrease in the shielding performance.

On the other hand, when the melting temperature Tq is at least 70° C., a hot offset phenomenon tends to hardly occur in the step of transferring the toner layer to the glass plate, and it is possible to prevent the molten toner from attaching to a photoreceptor or an intermediate transfer member, whereby a sufficient amount of the toner can be transferred to the glass plate. As a result, it becomes possible to readily obtain a ceramic color print having a uniform thickness and being thick (thickness: about 10 to 15 μm). Further, when a sufficient amount of the toner can be transferred to the glass plate, pinholes, cracks or voids tend to scarcely form after the baking, whereby the color difference ΔE can be made small, and the shielding performance can be increased. Tq is particularly preferably from 80° C. to 110° C.

Temperature Tη at which the Viscosity is 10⁵ Pa·s

The temperature Tη at which the viscosity of the binder resin is 10⁵ Pa·s, is preferably from 70 to 115° C. The binder resin has a heat decomposable property, and its viscosity decreases as the temperature rises. In the step of transferring the toner layer to the glass plate, when the viscosity of the binder resin contained in the toner is at a level of 10⁵ Pa·s or lower, the leveling property of the toner layer will be good. Accordingly, when Tη of the binder resin is at most 115° C., in the process of transferring the toner layer to the glass plate, the binder resin can easily be sufficiently melted. When the binder resin is sufficiently melted, the leveling property of the toner layer will be improved, and in the baking step, the binder resin tends to be uniformly decomposed. Accordingly, pinholes, cracks or voids are less likely to form in the ceramic color print. As a result, a ceramic color print excellent in smoothness will be obtained. Further, the color difference ΔE in the ceramic color print can easily be reduced, and sufficient shielding performance can easily be obtained. On the other hand, when Tη is at least 70° C., in the step of transferring the toner layer to the glass plate, a hot offset phenomenon tends to scarcely take place, and it is possible to prevent a molten toner from attaching to a photoreceptor or an intermediate transfer member, whereby a sufficient amount of the toner can be transferred to the glass plate. As a result, it becomes possible to easily obtain a thick ceramic color print having a uniform thickness, and at the same time, it is possible to prevent formation of pinholes, cracks or voids in the ceramic color print. Thus, it is possible to obtain a ceramic color print having a small color difference ΔE and excellent shielding performance. Tη is particularly preferably from 80° C. to 110° C.

### Type of Resin

The type of the binder resin is not particularly limited so long as the binder resin is a heat decomposable resin having T₁₀₀ of from 350 to 575° C. and has a function as a binder.

Especially, it is preferred that at least one of the monomer components constituting the binder resin is styrene or a styrene derivative in order to provide functions such that the toner will not undergo coagulation or the like before it is supplied to a photoconductor drum 13, the toner attaches to the photoconductor drum 13 at a proper attaching force, the toner layer on the photoconductor drum 13 is satisfactorily transferred to the substrate (the glass plate G), and further the fixing property of the toner layer transferred to the substrate is good. Namely, the binder resin is preferably a polymer containing monomer units derived from styrene. The reason is not clearly understood, but it is considered that in the heat decomposition process of the binder resin, a stabilized route is present such that styrene or a styrene derivative portion is depolymerized to form styrene or a styrene derivative excellent in resonance stabilization effects, and such styrene or styrene derivative will finally disappear, whereby the heat decomposition property of the binder resin will be good. In the total monomer units constituting the binder resin, the proportion occupied by monomer units derived from styrene is preferably at least 50 mol %, more preferably at least 60 mol %, and it may be 100 mol %. Further, the weight average molecular weight of the binder resin is not particularly limited, but it is preferably from 3,000 to 150,000, particularly preferably from 5,000 to 80,000.

Further, resins useful for the binder may be classified into the following three types depending upon the heat decomposition behaviors based on the above heat decomposition ratio. The first type is a resin such that the decomposition is completed up to 500° C. (the decomposition ratio is substantially 100%); the second type is a resin such that the decomposition ratio at 500° C. is at least 90%, but decomposition continues intermittently thereafter; and the third type is a resin such that the decomposition up to 500° C. is less than 90%.

With respect to typical resins of the respective types, the first type may, for example, be an acrylic resin (Acr), and the second type may be one such that the heat decomposition continues intermittently as the resin is converted to residual carbon, such as polystyrene (PS), styrene-acryl (Sty-Acr), polystyrene (PE) and PP resin. The third type includes various resins and is not limited to specific resins.

In order to carry out material design in consideration of the calorific value and the generation of gases, a resin of the first or second type is preferred, and a resin of the first type is more preferred.

### Glass Frit

Further, the glass frit may be either lead glass or non-lead glass, but preferred is non-lead bismuth-silica glass frit in view of a less load to environment, etc. The bismuth-silica glass frit is meant for glass frit containing bismuth and silicon as its components.

Further, the glass frit is preferably a powder having an average particle size of from 0.1 to 5 μm. When the glass frit has an average particles size of at least 0.1 μm, adhesion to the glass plate surface can be sufficiently secured. On the other hand, when the average particle size is at most 5 μm, exposure of the glass frit on the surface of toner matrix particles of the present toner can be prevented, whereby the fixing properties of the print pattern are less likely to decrease when the toner is printed on the glass plate surface by electro printing system. The glass frit is particularly preferably a powder having an average particle size of from 0.5 to 3 μm.

Here, the average particle size in this specification means a number average particle size. Such an average particle size can be measured by a known method. For example, it can be measured by using a particle image analyzing apparatus of e.g. a flow system, a laser diffraction-scattering system or a dynamic light scattering system. In this specification, a flow system particle image analyzing apparatus was used, since it is thereby possible to measure the presence or absence of coagulated particles accurately and to measure the particle shape at the same time as the average particle size.

The softening point of the glass frit is preferably from 500 to 600° C. When the softening point is at least 500° C., it is possible to prevent initiation of the melting of glass frit before the initiation of the decomposition of the resin, whereby it is possible to reduce the baking failure of the print pattern, i.e. to reduce agglomeration failure of fine inorganic pigment particles one another or adhesion failure of the ceramic color print. On the other hand, when the softening point is at most 600° C., it is possible to prevent decomposition and volatilization of the binder resin before the initiation of the melting of the glass frit, whereby the fixing properties of the toner will not decrease, and the adhesion of the ceramic color print to the glass plate surface can be secured. In this specification, the melting temperature of the glass frit is defined by the softening point of the glass frit.

The glass frit includes one having a nature of precipitating crystals (hereinafter referred to crystallizability) in the process of being further heated after being melted, and one having a nature of not precipitating crystals (hereinafter referred to as non-crystallizability). As the present toner, either the crystallizable glass frit or the non-crystallizable glass frit may be employed. In a case where thermal processing is carried out in the baking step (ST3), if the glass frit having crystallizability is employed, the glass frit will be crystallized at the thermal processing temperature, whereby the ceramic color print tends to be scarcely attached to a pressing die to be used at the time of press bending processing of the glass plate. Namely, such being preferred as the release property is thereby improved.

As the glass frit having crystallizability, there may, for example, be (1) a glass containing lithium, zinc and silicon as its components, which precipitates zinc silicate-lithium type crystals, (2) a glass containing bismuth and silicon as its components, which precipitates bismuth silicate crystals, and (3) one preliminarily containing seed crystals, which are precipitated during the baking. Specific examples of crystals which are precipitated during the baking in the above (3), include, for example, zinc silicate, boron silicate, lithium silicate, zinc titanate and lithium titanate. Here, the temperature for precipitating the crystals can be determined as the crystallizable peak temperature by a differential thermal analysis. The thermal processing temperature is preferably higher than the crystallizable peak temperature.

### Fine Inorganic Pigment Particles

The fine inorganic pigment particles are a component to block ultraviolet rays or to block ultraviolet rays and visible light, and a heat resistant pigment is preferably used. In order to obtain a black ceramic color print, it is preferred to employ, as fine inorganic pigment particles, an oxide of at least one metal selected from the group consisting of Co, Cr, Mn, Fe and Cu, or a composite oxide of two or more such metals. Specifically, it is particularly preferred to use at least one heat resistant pigment selected from the group consisting of Cu—Cr—Mn composite oxide, Cr—Co composite oxide, Fe—Mn composite oxide, Cr—Fe—Ni composite oxide, Cr—Cu composite oxide and magnetite, which are excellent in black color development properties.

The fine inorganic pigment particles preferably have an average particle size of from 0.1 to 5 μm. When the average particle size is at least 0.1 μm, shielding properties in the interior of the ceramic color print to be obtained can be maintained, whereby it is possible to prevent glass from being seen therethrough at the region where the ceramic color print is formed, when observed from the printed surface having the ceramic color print formed. On the other hand, when the average particle size is at most 5 μm, the print quality of the ceramic color print to be obtained can be made high. The fine inorganic pigment particles particularly preferably have an average particle size of from 0.1 to 3 μm.

### Blend Amounts

The present toner comprises from 10 to 50 parts by mass of the fine inorganic pigment particles, from 5 to 40 parts by mass of the present binder resin and from 40 to 85 parts by mass of the glass frit, per 100 parts by mass of the total solid content of the toner matrix particles.

When the content of the fine inorganic pigment particles is at least 10 parts by mass, sufficient shielding properties can be obtained as viewed from the printed surface. Further, when the content of the fine inorganic pigment particles is at most 50 parts by mass, the adhesion of the ceramic color print to the glass plate surface can be secured. The content of the fine inorganic pigment particles is particularly preferably from 15 to 40 parts by mass.

Further, when the content of the present binder resin is at least 5 parts by mass, the ceramic color print can be well fixed to the glass plate surface due to bonding properties of both of the resin and the glass frit in the baking step, and the adhesion of the ceramic color print to the glass plate surface can be increased. On the other hand, when the content of the present binder resin is at most 40 parts by mass, chars are less likely to remain in the ceramic color print after baking, and the adhesion of the ceramic color print to the glass plate surface can be sufficiently secured for a long period of time. Further, it is possible to prevent occurrence of defects such as pinholes, cracks or voids in the ceramic color print by decomposition of the resin. The content of the present binder resin is particularly preferably from 10 to 30 parts by mass.

Further, when the content of the glass frit is at least 40 parts by mass, the adhesion of the ceramic color print to the glass plate surface can be sufficiently secured for a long period of time. On the other hand, when the content is at most 85 parts by mass, the fine inorganic pigment particles can be dispersed at a high concentration in the ceramic color print, whereby shielding properties can be easily obtained. The content of the glass frit is more preferably from 45 to 80 parts by mass.

Further, in the present toner, the content ratio of the glass frit to the present binder resin is preferably such that by the mass ratio, (the glass frit)/(the present binder resin)≧1.5. Such a content ratio is more preferably 2 or higher. When the content ratio is at least the above lower limit, chars are less likely to remain in the ceramic color print after firing, and the adhesion of the ceramic color print to the glass plate surface can be sufficiently secured for a long period of time. Further, it is possible to prevent occurrence of defects such as pinholes, cracks or voids in the ceramic color print by decomposition of the resin. The upper limit of the content ratio of the glass frit to the present binder resin is preferably at most 10, that is, is by the mass ratio, (the glass frit)/(the present binder resin)≦10. It is more preferably at most 8. When the content ratio is at most the above upper limit, the present binder resin tends to remain when the glass frit starts to melt in the baking step. In such a case, the print pattern tends to be easily fixed to the glass plate surface due to bonding properties of both of the resin and the glass frit, and the adhesion of the ceramic color print to the glass plate surface can be thereby improved. The content ratio of the glass frit to the present binder resin is particularly preferably such that by the mass ratio, (the glass frit)/(the present binder resin)=2 to 8.

Further, in the present toner, the content ratio of the glass frit to the fine inorganic pigment particles is preferably such that by the mass ratio, (the glass frit)/(the fine inorganic pigment particles)≧1. When the content ratio is at least the above lower limit, the fine inorganic pigment particles can be highly dispersed in the ceramic color print and further they can be firmly fixed to the glass plate surface, whereby the adhesion of the ceramic color print to the glass plate surface can be sufficiently secured for a long period of time. The upper limit of the content ratio is preferably at most 5, i.e. (the glass frit)/(the fine inorganic pigment particles)≦5. When the content ratio is at most the above upper limit, it is possible to obtain a ceramic color print having a desired color tone and excellent in shielding properties. The content ratio of the glass frit to the fine inorganic pigment particles is particularly preferably such that by the mass ratio, (the glass frit)/(the fine inorganic pigment particles)=1.5 to 4.

### Other Blend Components

Depending upon the purpose of e.g. suppressing the decease in strength of the ceramic color print, or improving the release properties, an inorganic filler may be incorporated to the toner matrix particles. The inorganic filler is preferably a heat resistant inorganic filler, and it is more preferably a filler comprising at least one inorganic substance selected from the group consisting of aluminum borate, α-alumina, potassium titanate, zinc oxide, magnesium oxide, magnesium borate, basic magnesium sulfate and titanium diboride. The shape of the inorganic filler is not particularly limited, but a plate-like filler is preferred, whereby the shielding properties in the interior of the ceramic color print can be made high. With respect to the amount of the inorganic filler, the total amount of the fine inorganic pigment particles and the inorganic filler is within a range of the amount to satisfy the above described preferred ratio of the glass frit to the fine inorganic pigment particles. Namely, in a case where the inorganic filler is contained, it is preferred that 1≦(the glass frit)/(the fine inorganic pigment particles+the inorganic filler)≦5 by the mass ratio.

Further, other than the inorganic filler, another blend component may be incorporated to the toner matrix particles, as the case requires. For example, a charge controlling agent such as an azo metal-containing complex, a salicylic acid metal-containing complex a Fe-type bisazo complex, a tetraphenyl borate derivative, an aromatic hydroxycarboxylic acid derivative, an aliphatic hydroxycarboxylic acid derivative, calixarene derivative, a nigrosine complex, a triphenylmethane complex, a quaternary ammonium salt, an quaternary alkylammonium salt or a quaternary pyridinium salt may be incorporated in the toner matrix particles.

The blend amount of the charge controlling agent is suitably determined depending upon the type of the heat decomposable binder resin, the presence or absence of other additives, etc. Specifically, the blend amount of the charge controlling agent is preferably at most 10 parts by mass per 100 parts by mass of the present binder resin. When the blend amount is at most 10 parts by mass, it is possible to prevent the decomposition behavior of the organic group portion of the charge controlling agent from hindering the decomposition of the present binder resin. As a result, it is possible to prevent the chars from remaining in the ceramic color print or to prevent pores from remaining at the interface between the ceramic color print and the glass substrate. Further, even in a case where a charge controlling agent made of a metal-containing complex is used, when the blend amount is at most 10 parts by mass, it is possible to prevent migration of metal ions in the ceramic color print during the thermal processing thereby to prevent a change in the color tone. The blend amount of the charge controlling agent is particularly preferably at most 5 parts by mass.

The total content of the fine inorganic pigment particles, the present binder resin and the glass frit in the toner matrix particles of the present toner is preferably at least 80 mass %, more preferably at least 90 mass %. It may be 100 mass %.

### Process for Producing Toner

The toner matrix particles of the present toner are produced, for example, by mixing the present binder resin, the fine inorganic pigment particles, the glass frit and, if necessary, other blend components, kneading and cooling the mixture to prepare pellets, followed by pulverization and classification. The heating temperature at the time of kneading is preferably from 100 to 200° C. When the heating temperature is at least 100° C., the resin, the fine inorganic pigment particles, the glass frit, etc. can be uniformly mixed. On the other hand, when the heating temperature is at most 200° C., it is possible to prevent decomposition or deterioration of the present binder resin at the stage for preparation of the toner matrix particles.

### Particle Size

The toner matrix particles are preferably particulate with an average particle size of from 5 to 50 μm. When the average particle size is at least 5 μm, the fine inorganic pigment particles and the glass frit in the toner matrix particles will not be exposed to the surface, and the amount of electrification of the present toner can be secured, whereby occurrence of printing failure such as fogging due to an insufficient amount of electrification of the present toner can be suppressed at the time of electro printing. On the other hand, when the average particle size is at most 50 μm, high definition print quality can readily be obtained.

### External Additive

The present toner may be one having fine particulate material (hereinafter referred to as an external additive) dispersed and deposited on the surface of toner matrix particles. Such an external additive has a function to maintain the high flowability of the present toner until the present toner is supplied to the photoconductor drum 13 without impairing the transfer ratio from e.g. the photoconductor drum 13 to the glass plate surface. Further, it also has a function to improve the electrostatic charge of the present toner. The type of the external additive is not particularly limited, and fine inorganic particles made of e.g. silica, titania or alumina, or fine particles of a heat decomposable organic resin, may, for example, be suitably used. Fine inorganic particles are particularly preferred in that it is thereby unnecessary to take into consideration the decomposition of the external additive at the heating temperature during the baking.

The average particle size of the external additive is preferably from 5 to 800 nm. If the average particle size is at least 5 nm, it tends to be easy to obtain the effects to improve the flowability of the present toner and to maintain the image quality and the transfer ratio. On the other hand, when the average particle size is at most 800 nm, the external additive will be uniformly dispersed on the surface of toner matrix particles, whereby the flowability of the present toner can be improved. The ratio of the average particle size of the external additive to the average particle size of the toner matrix particles is preferably adjusted to be within a range of (particle size of external additive)/(particle size of toner matrix particles)=0.0001 to 0.05, whereby the effect to improve the flowability of the present toner can easily be obtained.

Further, the shape of the external additive is preferably spherical, whereby the external additive can uniformly be deposited on the surface of toner matrix particles, and the effect to improve the flowability of the present toner can easily be obtained.

The amount of the external additive to be added, is preferably from 0.05 to 10 parts by mass, per 100 parts by mass of the toner matrix particles. When the amount is at least 0.05 part by mass, the effects to improve the flowability of the present toner and to improve the image quality and the transfer ratio, can easily be obtained. On the other hand, when the amount of the external additive to be added is at most 10 parts by mass, it is possible to prevent a non-volatile component contained in the external additive from remaining in the ceramic color print to impair the adhesion to the glass plate surface. The amount of the external additive is more preferably from 0.1 to 5 parts by mass, per 100 parts by mass of the toner matrix particles.

The external additive may be deposited on the toner matrix particles by means of a mixing machine such as a particle compounding apparatus represented by a hybridization system (manufactured by NARA MACHINERY CO., LTD.), a Henschel mixer or other mixers.

### Thickness of Ceramic Color Print

The thickness of the ceramic color print is preferably from 5 to 30 μm. When the thickness is at least 5 μm, stable shielding properties will be easily obtained. When the thickness is at most 30 μm, a desired thickness will easily be achieved only by electro printing once, and such makes the process simple without requiring a multiple printing. The thickness of the ceramic color print is more preferably from 10 to 20 μm, particularly preferably from 10 to 15 μm.

### Inspection Step (ST4)

FIG. 2 is a chart schematically illustrating a control process according to a preferred embodiment of the present invention. As mentioned above, on a glass plate pre-treated in the pretreatment step (ST1), a predetermined print pattern is printed in the printing step (ST2) and heated in the baking step (ST3) to bake the print pattern to form a pattern of a ceramic color print. Thus, a glass plate provided with a ceramic color print is produced.

After the baking step (ST3), the shielding performance of the ceramic color print in the glass plate provided with the ceramic color print, is measured in the inspection step (ST4). The data regarding the shielding performance measured are transmitted to a computer C which controls the print pattern in the printing step (ST2). As the case requires, the temperature data in the baking step (ST3) are also transmitted to the computer C. Based on the data transmitted, the computer C will judge whether the desired shielding performance or color has been obtained. In a case where it is judged that no desired performance has been obtained, the shape of the print pattern and the toner supply amount are adjusted by the operation of the computer C to achieve the desired performance. The data of the adjusted shape of the print pattern and toner supply amount are fed back to the printing step (ST2) and reflected to the conditions to form a print pattern on the next glass plate.

When the desired shielding performance or color is obtained by such feedback, the control data are fixed to produce a large amount of glass plates provided with a ceramic color print continuously.

Further, as mentioned above, the power source 15 is also controlled by the computer C.

As an index for the shielding performance, the visible light transmittance is used, and as an index for the color, the color difference ΔE is used. The visible light transmittance of the glass plate provided with a ceramic color print obtained by the present invention is preferably at most 2.5%, more preferably at most 1.0%, further preferably at most 0.7%, particularly preferably at most 0.3%. Further, the color difference ΔE is preferably at most 2.0, more preferably at most 1.2, particularly preferably at most 1.0.

Further, in a case where the glass plate G is used for a window of an automobile, it is possible to store and accumulate data regarding shapes of various glass plates depending upon the models of automobiles, data regarding pattern shapes etc., in the computer C. Accordingly, in production of a glass plate provided with a ceramic color print for a certain model, commands based on data regarding the pattern shape corresponding to the model are transmitted to the printing step (ST2), the baking step (ST3) and the inspection step (ST4), whereby it is easy to change printing for a certain model to printing for another model and to carry out printing depending upon each model. Further, it is possible to easily change printing for a certain model to printing for another model and to carry out cutting and chamfering depending upon each model, by transmitting commands based on data regarding the shape of a glass plate among data regarding the model to a pretreatment step (ST1) of the glass plate.

### Modification

In the above embodiment, only printing by using a color toner was carried out in the printing step (ST2), but printing by using such a color toner and printing by using a toner containing fine conductive particles (hereinafter referred to as a conductive toner) may be carried out sequentially. The sequential order is optional, but it is preferred to carry out printing by using a conductive toner after carrying out printing by using a color toner, in order to form a glass plate for a rear window of an automobile excellent in the shielding performance from the exterior side of the car. For example, on a rear window for an automobile shown in FIG. 3, electrically conductive printed wires (defogger 1, antenna wire 2, bus bar 3) are provided at a center region of a glass plate G and a dark ceramic print 4 is provided at the peripheral region. It is possible to print a print pattern of the electrically conductive toner together with a print pattern of the color toner on the same glass plate by further providing a step of printing the electrically conductive toner with a predetermined pattern on the photoconductor drum 13 shown in FIG. 1.

The electrically conductive toner may be prepared, for example, by substituting all of the fine inorganic particles in the present toner by fine electrically conductive particles.

Like a color toner, an electrically conductive toner used to be printed by screen printing. Thus, by electro printing of the electrically conductive toner together with the color toner by the present invention, it is possible to provide a process suitable for mass production.

According to the present invention, a color toner can be printed with a prescribed pattern on a glass plate surface by electro printing, followed by baking to form a ceramic color print layer with a prescribed pattern on the glass plate surface. Accordingly, it is not required to prepare a screen plate for every pattern. Particularly, even when the pattern is to be changed, such can be done simply by replacing the electronic information, and accordingly, production of many types in small quantities can be met in a short time.

According to the present invention, a ceramic color print excellent in shielding performance can easily be printed on a glass plate surface. Further, the ceramic color print thereby obtained, has good adhesion to the glass plate, and the color of the ceramic color print as observed from the non-printed surface (the surface on the opposite side of the surface on which the ceramic color print is formed) of the glass plate, is close to the desired color to be obtained. Namely, it is possible to obtain a ceramic color print of high quality with a color difference (hereinafter referred to also as ΔE) being small.

### EXAMPLES

Now, the present invention will be described in further detail with reference to Examples 1 to 4 and 7 and 8 (Working Examples of the present invention) and Examples 5, 6 and 9 (Comparative Examples), but it should be understood that the present invention is by no means thereby restricted.

### Evaluation of Binder Resin

Decomposition temperature T₁₀₀ (° C.): Using a differential thermal analyzer (TG-DTA2000SR, manufactured by Bruker AXS), measurement was carried out from room temperature to 700° C. at a heating rate of 10° C./min, and the temperature in the DTA graph at which heat generation was no longer observed, was taken as the decomposition temperature. Tfb, Tq (° C.): A die of 1.0 mm in diameter×2.0 mm was set in a flow tester (CFT-500, manufactured by Shimadzu Corporation) and 1 g of a binder resin was melted and flowed through the die under conditions of a load of 980 N and a heating rate of 6° C./min to obtain a rheogram, from which the starting point and terminal point of flow were obtained. The temperature at the starting point of flow was taken as Tfb, and the temperature corresponding to ½ of the difference between the piston stroke Smax at the terminal point of flow and the piston stroke 5 min at the initial point of flow ((Smax−Smin)/2) was taken as Tq. Tη (° C.): In the temperature-viscosity characteristic curve of the binder resin measured by using the above flow tester, the temperature at which the viscosity of the molten resin was 10⁵ Pa·s, was taken as TV.

### Average Particle Size of Particles

The average particle size of particles is the number average value of circle-corresponding diameters measured by using a flow system particle image analyzer (tradename: FPIA-3000, manufactured by Sysmex).

### Evaluation of Glass Frit

Using the above differential thermal analyzer, the softening point and the crystallization peak temperature were obtained.

### Example 1

In a container made of stainless steel (SUS304) having a capacity of 200 mL, 20 parts by mass of polypropylene (manufactured by Sanyo Chemical Industries, Ltd., tradename: Hymer ST-95, weight average molecular weight 4,000, T₁₀₀=410° C., Tfb=72.5° C., Tq=89.4° C., Tη=81° C., Q=14.4 μV/mg) as the preset binder resin, 18 parts by mass of fine black heat resistant pigment particles comprising Cu—Cr—Mn composite oxide (manufactured by Tokan Material Technology Co., Ltd., tradename: 42-302A, average particle size 0.9 μm) and 62 parts by mass of crystallizable glass frit (bismuth-silica non-lead frit, softening temperature Tg=626° C., average particle size: 2 μm) were put, mixed, heated to 170° C. and kneaded, and then cooled to room temperature to obtain a solid. The solid was pulverized and classified to obtain toner matrix particles having an average particle size of 20 μm.

To 99.5 parts by mass of the toner matrix particles thus obtained, 0.5 part by mass of fine spherical silica particles (manufactured by Nippon Aerosil Co., Ltd., tradename: AEROSIL R202, average particle size: about 14 nm, not decomposed at 700° C.) were added, and by means of a tumbler shaker mixer T2F model (manufactured by Shinmaru Enterprises Corporation), the fine spherical silica particles were attached to the toner matrix particles to obtain a toner for electro printing having an average particle size of 20 μm.

Using this toner for electro printing, a rectangular print pattern of 37 mm×20 mm was printed on a glass plate made of soda lime glass (10 cm×10 cm×3.5 mm) by an electro printing machine and then baked at 700° C. for 4 minutes to form a ceramic color print. The thickness of the ceramic color print was 7 μm. With respect to the glass plate provided with a ceramic color print thus obtained, the visible light transmittance, the color difference, the adhesion and the release property were evaluated by the following methods. The results are shown in Table 1.

Also in the following Examples 2 to 6, evaluation was carried out in the same manner, and the evaluation results are shown in Table 1.

### Visible Light Transmittance

The visible light transmittance in the pattern-formed region, of the glass plate provided with a ceramic color print, was measured by a spectrophotometer (manufactured by MINOLTA, spectrophotometer CM-3600d).

The smaller the value of the visible light transmittance, the higher the shielding performance.

### Color Difference

The color tone, as seen from the non-printed surface (the surface on the opposite side of the surface on which the ceramic color print was formed), of the pattern-formed region of the glass plate provided with the ceramic color print, was measured by the above spectrophotometer, and the difference from the standard color (L*=25.27, a*=−0.47, b=−0.66) was taken as the color difference ΔE.

### Adhesion

The pattern-formed region of the glass plate provided with a ceramic color print was observed from the non-printed surface (the surface on the opposite side of the surface on which the ceramic color print was formed) by an optical microscope, and the presence or absence of separation or adhesion failure of the ceramic color print was confirmed. Here, the adhesion failure means such a state that the ceramic color print does not adhere to the glass plate surface but is floating. The evaluation was made based on the following standards. ◯: 5 or less adhesion failures with a diameter of at most 0.5 mm observed at the interface between the glass plate and the ceramic color print, Δ: at least 6 adhesion failures with a diameter of 0.5 mm or an adhesion failure with a diameter exceeding 0.5 mm was observed, but no separation of the ceramic color print was observed, and X: separation of the ceramic color print was observed.

### Release Property

In the same manner as described above, a rectangular pattern of 37 mm×20 mm was printed on a glass plate made of soda lime glass (10 cm×10 cm×3.5 mm) by an electro printing machine and then, inserted between a convex press die and a concave press die each having a glass cloth lined on the surface facing to the other surface and maintained to be 670° C. A weight of 10 kg was placed on the convex press die, and pressing was carried out for 5 minutes. Then, the weight and the convex press mold were removed, and the state of attachment of the ceramic color print to the glass cloth surface of the convex press die was examined to evaluate the release property. One having no attachment of the ceramic color print observed was judged to be “acceptable”.

### Example 2

A toner for electro printing having an average particle size of 20 μm was obtained by carrying out the operation in the same manner as in Example 1 except that as the present binder resin, polystyrene (manufactured by Toagosei K.K., tradename: ARUFON UP-1150, weight average molecular weight: 5,300, T₁₀₀=420° C., Tfb=80.0° C., Tq=98.0° C., Tη=89° C., Q=24 μV/mg) was used.

### Example 3

A toner for electro printing having an average particle size of 20 μm was obtained by carrying out the operation in the same manner as in Example 1 except that as the present binder resin, polystyrene (manufactured by Sanyo Chemical Industries, Ltd., tradename: Hymer ST-120, weight average molecular weight: 10,000, T₁₀₀=430° C., Tfb=91.8° C., Tq=109.2° C., Tη=1,000° C., Q=14.7 μV/mg) was used.

### Example 4

A toner for electro printing having an average particle size of 20 μm was obtained by carrying out the operation in the same manner as in Example 1 except that as the present binder resin, a styrene/acrylate copolymer resin (manufactured by Sanyo Chemical Industries, Ltd., tradename: Hymer SB-305, weight average molecular weight: 220,000, T₁₀₀=410° C., Tfb=102.8° C., Tq=125.8° C., Tη=89° C., Q=32.0 μV/mg) was used.

### Example 5

### Comparative Example

A toner for electro printing having an average particle size of 20 μm was obtained by carrying out the operation in the same manner as in Example 1 except that instead of the present binder resin, a styrene/acrylate copolymer resin (manufactured by Toagosei K.K., tradename: ARUFON UC-3900, weight average molecular weight: 4,500, T₁₀₀=580° C., Tfb=96.2° C., Tq=112.9° C., Tη=104° C., Q=13.9 μV/mg) was used.

### Example 6

### Comparative Example

A toner for electro printing having an average particle size of 20 μm was obtained by carrying out the operation in the same manner as in Example 1 except that instead of the present binder resin, a polyester resin (manufactured by Mitsubishi Rayon, tradename: ER-535, weight average molecular weight: 6,600, T₁₀₀=640° C., Tfb=81.3° C., Tq=95.5° C., Tη=87° C., Q=23.2 μV/mg) was used.

### Example 9

### Comparative Example

A toner for electro printing having an average particle size of 20 μm was obtained by carrying out the operation in the same manner as in Example 1 except that instead of the present binder resin, a styrene/acryl resin (manufactured by Sekisui Chemical, tradename: S-LEC P P-11040, weight average molecular weight: 29,000, T₁₀₀=385° C., Tfb=81.3° C., Tq=95.5° C., Tη=87° C., Q=109.1 μV/mg) was used.

TABLE 1

| | Visible light | | | |
|---|---|---|---|---|
| | transmittance | Color | | Release |
| | (%) | difference | Adhesion | property |
| Ex. 1 | 0.02 | 0.56 | ◯ | Acceptable |
| Ex. 2 | 0.18 | 0.4 | ◯ | Acceptable |
| Ex. 3 | 0.23 | 0.73 | ◯ | Acceptable |
| Ex. 4 | 2.01 | 0.73 | Δ | Acceptable |
| Ex. 5 | 0.07 | 2.03 | Δ | Acceptable |
| Ex. 6 | Not measured | Not | X | Not |
| | (film | measured | | measured |
| | ruptured) | (film | | (film |
| | | ruptured) | | ruptured) |
| Ex. 9 | Not measured | Not | X | Not |
| | (film | measured | | measured |
| | ruptured) | (film | | (film |
| | | ruptured) | | ruptured) |

From the results in Table 1, it is evident that in Examples employing the present toner (Examples 1 to 4), the adhesion of the ceramic color print to the glass plate surface is good, and the color difference can be suppressed to be small. Especially, it is evident that in Examples 1 to 3, a glass plate provided with a ceramic color print is obtainable which is excellent in adhesion and has a small color difference and which has an extremely low visible light transmittance and is excellent in the shielding performance.

Whereas, in Example 5 employing a styrene/acrylate copolymer resin having T₁₀₀=580° C. instead of the present is binder resin, the color difference increases to a large extent, although the visible light transmittance is good, and the adhesion is also good. Further, in Example 6 using a polyester resin having T₁₀₀=640° C. instead of the present binder resin, rupture of the ceramic color print (film rupture) takes place during the baking. Further, in Example 9 using a styrene/acryl resin having Q=109.1 μV/mg instead of the present binder resin, rupture of the ceramic color print (film rupture) takes place during the baking.

### Example 7

Using the toner for electro printing obtained in Example 3, a rectangular print pattern of 198 mm×32 mm was printed on a glass plate made of soda lime glass (30 cm×30 cm×3.5 mm) by an electro printing machine and then baked at 700° C. for 4 minutes to form a ceramic color print. The thickness of the ceramic color print was 7 μm. With respect to the glass plate provided with the ceramic color print thus obtained, the visible light transmittance, the color difference and the release property were evaluated in the same manner as in Example 1. The evaluation results are shown in Table 2.

### Example 8

A ceramic color print was formed by carrying out the operation in the same manner as in Example 7 except that the toner for electro printing obtained in Example 4 was used. With respect to the obtained ceramic color print, evaluation was carried out in the same manner as in Examples 1 to 7. The evaluation results are shown in Table 2.

TABLE 2

| | Visible light | | | |
|---|---|---|---|---|
| | transmittance | Color | | Release |
| | (%) | difference | Adhesion | property |
| Ex. 7 | 0.07 | 0.74 | ◯ | Acceptable |
| Ex. 8 | 0.52 | 1.00 | ◯ | Acceptable |

From the results in Table 2, it is evident that in each of Examples using the present toner (Examples 7 and 8), a glass plate provided with a ceramic color print which has a small color difference, is excellent in adhesion of the ceramic color print to the glass plate surface, has a low visible light transmittance and is excellent in shielding performance, was obtained even when electro printing was carried out on a glass plate having a large area.

The present invention relates to a process for providing a ceramic color print on a glass plate surface and a toner for electro printing therefor, and it is particularly suitably applicable to a process for producing a glass plate provided with a ceramic color print for a window of an automobile.

The entire disclosure of Japanese Patent Application No. 2007-097306 filed on Apr. 3, 2007 including specification, claims, drawings and summary is incorporated herein by reference in its entirety.

What is claimed is:

1. A color toner for electro printing, which comprises toner matrix particles containing from 10 to 50 parts by mass of fine inorganic pigment particles, from 5 to 40 parts by mass of a heat decomposable binder resin having a disappearance temperature T₁₀₀ of from 350 to 575° C., and from 40 to 85 parts by mass of glass frit, per 100 parts by mass of the total solid content of the toner matrix particles, the color toner, wherein the maximum value Q obtained by dividing the calorific value at the time of combustion of the heat decomposable binder resin by the measured resin weight is at most 100 μV/mg.

2. The color toner for electro printing according to claim 1, wherein the heat decomposable binder resin is such that decomposition of at least 90% thereof is at 500° C.

3. The color toner for electro printing according to claim 1, wherein the heat decomposable binder resin has a melting temperature Tq of from 70 to 126° C.

4. The color toner for electro printing according to claim 1, wherein the temperature Tη at which the viscosity of the heat decomposable binder resin is 10⁵ Pa·s, is from 70 to 115° C.

5. The color toner for electro printing according to claim 1, wherein the heat decomposable binder resin is a polymer containing monomer units derived from styrene.

6. The color toner for electro printing according to claim 1, wherein the glass frit has crystallinity.

7. The color toner for electro printing according to claim 1, wherein the heat decomposable binder resin is a polymer containing monomer units derived from styrene.

8. The color toner for electro printing according to claim 1, wherein the glass frit has crystallinity.

9. A process for producing a glass plate provided with a ceramic color print, which comprises a printing step of forming, by using the color toner for electro printing as defined in claim 1, a print pattern made of the color toner for electro printing by electro printing system on a glass plate, and a baking step of heating the glass plate having the print pattern formed thereon to convert the print pattern into a ceramic thereby to form a pattern of a ceramic color print.

10. The process for producing a glass plate provided with a ceramic color print according to claim 9, wherein the heating temperature in the baking step is from 600 to 740° C.

11. The process for producing a glass plate provided with a ceramic color print according to claim 9, wherein in the baking step, not only the print pattern is converted into a ceramic, but also the glass plate having the print pattern formed thereon is subjected to thermal processing.

12. A glass plate provided with a ceramic color print, which has a pattern of a ceramic color print formed on a glass plate surface by printing and baking the color toner for electro printing as defined in claim 1.

13. The glass plate provided with a ceramic color print according to claim 12, wherein the printing system is an electro printing system.

14. The glass plate provided with a ceramic color print according to claim 12, wherein the color difference (ΔE) of the ceramic color print formed on the glass plate surface is at most 1.0.
